(19) United States
(12) Patent Application Publication
(10) Pub. No.: US 2026/0336072 A1
(43) Pub. Date: Oct. 29, 2026

(54) TOOL WITH QUICK-RELEASE BITS

(71) Applicant: Shi-Yi Huang, Changhua City (TW)

(72) Inventor: Shi-Yi Huang, Changhua (TW)

(21) Appl. No.: 19/193,856

(22) Filed: Apr. 29, 2025

(51) Int. Cl. B25B 23/00

(52) U.S. Cl. CPC B25B 23/0035

(57) ABSTRACT

A tool with quick-release bits may include a connecting rod, a sliding sleeve, and a quick release member. The connecting rod has a rod body, a connecting section, and a stop edge, and a first positioning ball is embedded in the connecting section. The connecting section is recessed with a receiving hole, and a first spring and a positioning pin are sequentially accommodated into the receiving hole. The sliding sleeve comprises a first end and a second end, and a driving hole extends through the two ends, and a locking groove is formed in the driving hole. The sliding sleeve is sleeved onto the connecting section, and the first spring pushes the positioning pin into the locking groove. The quick release member has a connecting ring, an elastic member, a stop clip, and a cylindrical body, and the cylindrical body comprises a first opening and a second opening.

### FIELD OF THE INVENTION

The present invention relates to a tool structure and more particularly to a structure that selectively allows for the connection of either a socket or a screwdriver tool bit for quick attachment and detachment.

### BACKGROUND OF THE INVENTION

Referring to FIGS. 9 and 13 (referring to U.S. Pat. No. 10,377,024), a conventional quick-release tool structure comprises a main body (60), a sliding sleeve (61), a first spring (62), and a positioning pin (63). The main body (60) has a cylindrical rod body (601), and one end of the rod body (601) is formed with a plurality of equiangular cut surfaces (602), thereby defining a quadrilateral-shaped connecting section (603). The reduced diameter created by the cut surfaces (602) also forms a stop edge (604) at the junction between the rod body (601) and the connecting section (603). Furthermore, a positioning ball (605) is embedded in the connecting section (603), and a receiving hole (606) is recessed therein. A magnetic member may be embedded, as needed, at a lateral end of the connecting section (603). The sliding sleeve (611) has a first end (611) and a second end (612), and a quadrilateral-shaped driving hole (613) is adapted to extend through the first end (611) and the second end (612), and a locking groove (614) annularly formed within the driving hole (613) is located adjacent to the first end (611). The locking groove (614) is connected to the driving hole (613) toward the second end (612) through a guiding surface (615). Each of side walls of the driving holes (613) has a notch (616) formed at a central portion thereof, and the first spring (62) and the positioning pin (63) are sequentially inserted into the receiving hole (606) of the main body (60), and the sliding sleeve (61) is sleeved onto the connecting section (603) through the driving hole (613), so that the first spring (62) is adapted to push the positioning pin (63) into the locking groove (614), or the first end (611) and the stop end (604) are abutted against each other to allow the sliding sleeve (61) to perform a limited sliding movement on the main body (60).

When in use, the sliding sleeve (61) is pushed rearward, allowing the connecting section (603) to extend forward out of the driving hole (613), thereby enabling the exposed connecting section (603) to be connected to a socket (70) (as shown in FIG. 11). As the sliding sleeve (61) is pushed rearward, the first end (611) is configured to be abutted against the stop edge (604), thereby securely stopping the sliding sleeve (61) to prevent disengagement or detachment. Conversely, when the sliding sleeve (61) is pushed forward, the connecting section (603) is fully retracted into the driving hole (613), thereby forming a space within the driving hole (613) for insertion of a screwdriver tool bit (80) (as shown in FIGS. 12 and 13). When the sliding sleeve (61) is pushed forward, the positioning pin (63), abutted by the elastic force of the spring (62), automatically engages with the locking groove (614), thereby limiting the maximum travel position of the sliding sleeve (61).

However, the conventional quick-release tool structure has following disadvantages: Although pushing the sliding sleeve (61) forward allows a space to be formed within the driving hole (613) for insertion of the screwdriver tool bit (80), the simple insertion mechanism may result in the screwdriver tool bit (80) being directly ejected from the driving hole (613) by the connecting rod body (60) when the sliding sleeve (61) moves rearward. As a result, the screwdriver tool bit (80) must be manually retrieved and may be prone to loss, thereby posing certain inconveniences during use. Therefore, there remains a need for a new and improved design for a tool with quick-release bits to overcome the problems presented above.

### SUMMARY OF THE INVENTION

The present invention provides a tool with quick-release bits comprising a connecting rod, a sliding sleeve, and a quick release member. The connecting rod has a cylindrical rod body, and a plurality of equally-angled cut surfaces are formed on an outer periphery of one end of the rod body to form a quadrilateral-shaped connecting section, and with the cut surfaces, the rod body has a reduced outer diameter on the connecting section, so that a stop edge is formed at the junction between the rod body and the connecting section. A first positioning ball is embedded in the connecting section, and the connecting section is recessed with a receiving hole, and a first spring and a positioning pin are sequentially accommodated into the receiving hole. The sliding sleeve comprises a first end and a second end, and a driving hole with a quadrilateral-shaped cross section extends through between the first end and the second end. A locking groove formed in the driving hole is located adjacent to the first end, and the locking groove is connected to the driving hole toward the direction of the second end through a guiding surface, and at least two opposite edges of the driving hole respectively have a notch at a central portion thereof. The sliding sleeve is sleeved onto the connecting section through the driving hole, and the first spring is adapted to push the positioning pin into the locking groove to engage each other, or through mutual abutment between the first end and the stop edge, the sliding sleeve is configured to slide within a limited range on the connecting rod. A reduced diameter section located away from the first end is formed on an outer periphery of the sliding sleeve, and at least a through hole is formed on the reduced diameter section. The through hole communicated with the driving hole is adapted to accommodate a second positioning ball. The quick release member has a connecting ring, an elastic member, a stop clip, and a cylindrical body, and the connecting ring and the elastic member are sequentially sleeved onto the reduced diameter section of the sliding sleeve, and the stop clip is engaged with the reduced diameter section to prevent the elastic member and the connecting ring from detaching from the reduced diameter section, and the elastic member is compressed between the connecting ring and the stop clip. The cylindrical body comprises a first opening and a second opening, and a diameter of the second opening is smaller than a diameter of the first opening, so that the second opening is connected to the cylindrical body through an inclined section. When the cylindrical body is fitted over the stop clip, the elastic member, and the connecting ring on the reduced diameter section, the first opening and the connecting ring are mutually and securely engaged. The cylindrical body is adapted to drive the connecting ring to have displacement, and when released, the connecting ring is pushed back by the elastic member, so that the inclined section is configured to control the protrusion or retraction of the second positioning ball.

Comparing with conventional tool with quick-release bits, the present invention is advantageous because: by utilizing the quick release member to securely lock the screwdriver tool bit when the screwdriver tool bit is inserted into the driving hole, the sliding sleeve is prevented from being pushed backward, and the connecting section is consequently unable to extend out of the driving hole. As a result, the screwdriver tool bit has no risk to be directly ejected from the driving hole by the connecting rod, so as to eliminate the need to pick the screwdriver tool bit again or the potential the screwdriver tool bit to be lost, thereby making the tool with quick-release bits of the present invention significantly more convenient to use.

### BRIEF DESCRIPTION OF THE DRAWINGS

FIG. 1 is a three-dimensional perspective view of a tool with quick-release bits of the present invention.

FIG. 2 is an exploded perspective view of the tool with quick-release bits of the present invention.

FIG. 3 is a sectional assembly view of the tool with quick-release bits of the present invention.

FIG. 4 is a schematic view illustrating a cylindrical body is pushed forward and backward to connect various screwdriver tool bit in the present invention.

FIG. 5 is a schematic view illustrating a screwdriver tool bit is secured with the tool with quick-release bits of the present invention.

FIG. 6 is a sectional view illustrating a connecting section is exposed after a sliding sleeve is moved backward in the present invention.

FIG. 7 is a three-dimensional perspective view illustrating the connecting section is exposed after the sliding sleeve is moved backward in the present invention.

FIG. 8 is a schematic view illustrating a socket is connected in the present invention.

FIG. 9 is a prior art.

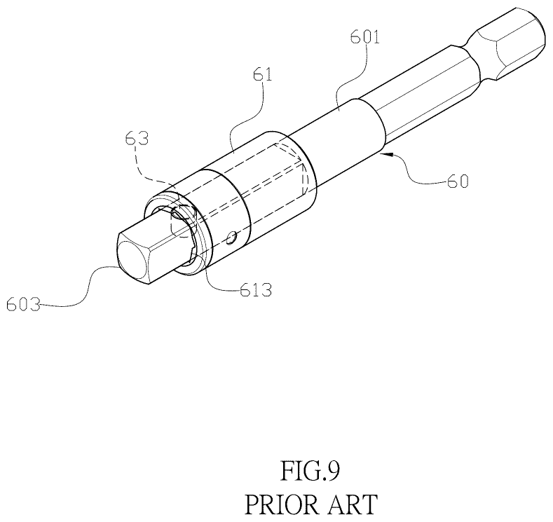

FIG. 10 is a prior art.

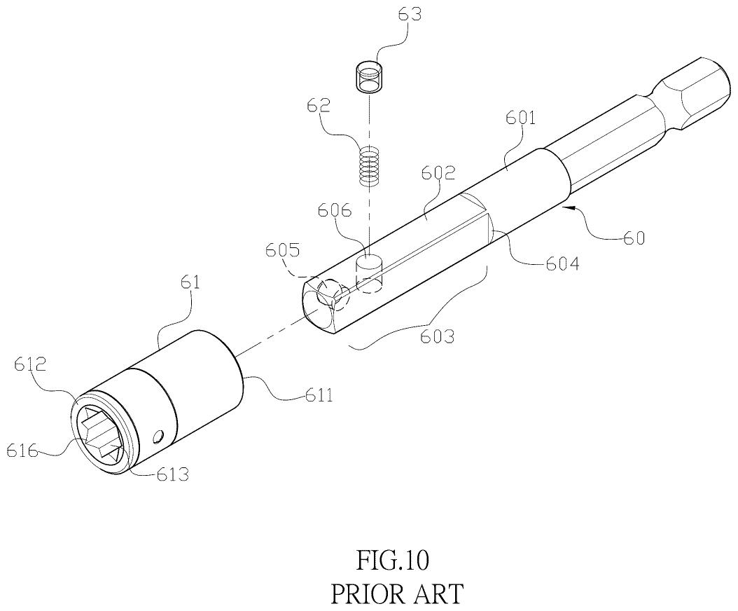

FIG. 11 is a prior art.

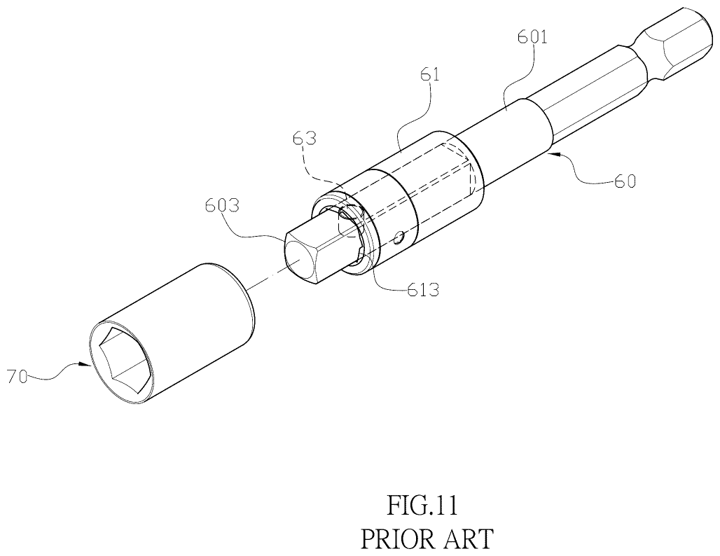

FIG. 12 is a prior art.

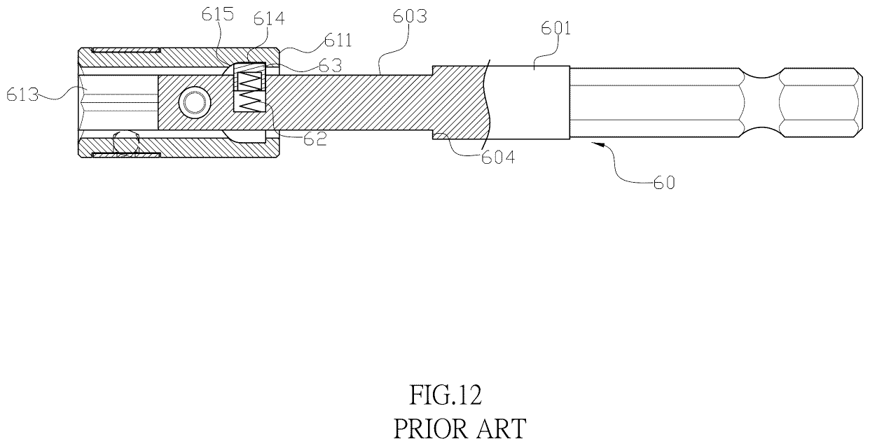

FIG. 13 is a prior art.

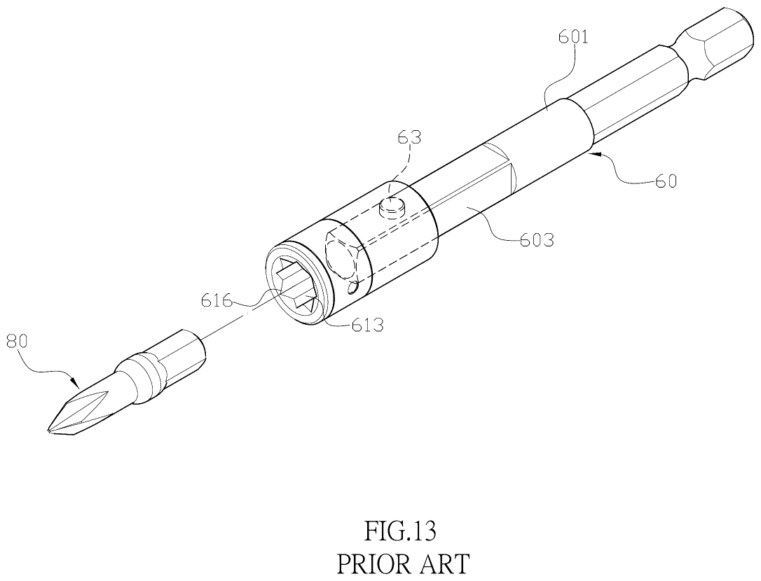

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

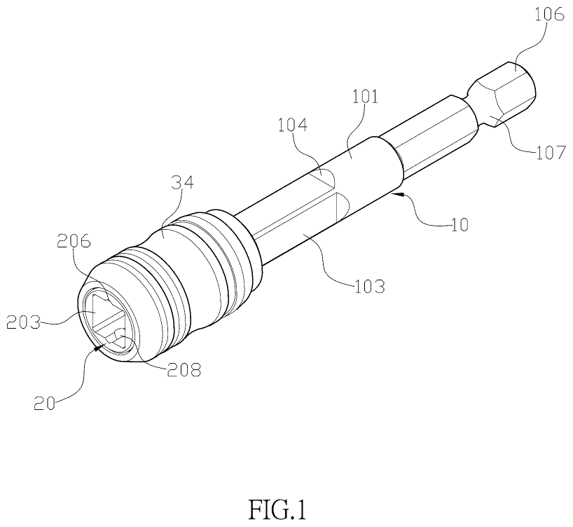

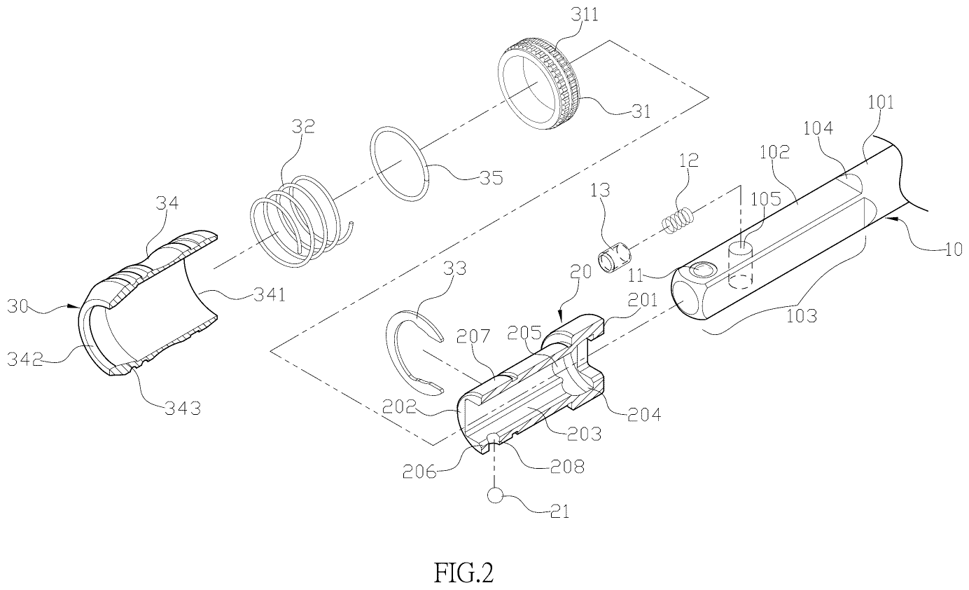

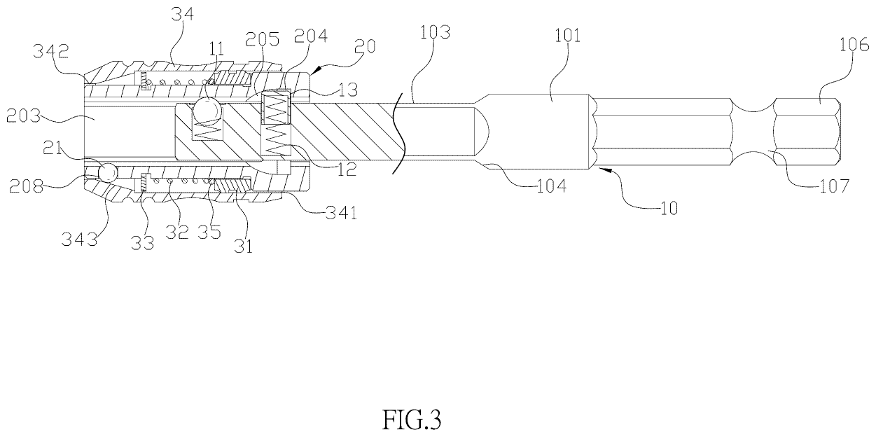

Referring to FIGS. 1 to 3, the present invention provides a tool with quick-release bits comprising a connecting rod (10), a sliding sleeve (20), and a quick release member (30). The connecting rod (10) has a cylindrical rod body (101), a plurality of equally-angled cut surfaces (102) are formed on an outer periphery of one end of the rod body (101) to form a quadrilateral-shaped connecting section (103), and with the cut surfaces (102), the rod body (101) has a reduced outer diameter on the connecting section (103), so that a stop edge (104) is formed at the junction between the rod body (101) and the connecting section (103). Moreover, a first positioning ball (11) is embedded in the connecting section (103), and the connecting section (103) is recessed with a receiving hole (105), and a first spring (12) and a positioning pin (13) are sequentially accommodated into the receiving hole (105). The sliding sleeve (20) comprises a first end (201) and a second end (202), and a driving hole (203) with a quadrilateral-shaped cross section extends through between the first end (201) and the second end (202). Also, a locking groove (204) formed in the driving hole (203) is located adjacent to the first end (201), and the locking groove (204) is connected to the driving hole (203) toward the direction of the second end (202) through a guiding surface (205), and at least two opposite edges of the driving hole (203) respectively have a notch (206) at a central portion thereof. The sliding sleeve (20) is sleeved onto the connecting section (103) through the driving hole (203), and the first spring (12) is adapted to push the positioning pin (13) into the locking groove (204) to engage each other, or through mutual abutment between the first end (201) and the stop edge (104), the sliding sleeve (20) is configured to slide within a limited range on the connecting rod (10). In addition, a reduced diameter section (207) located away from the first end (201) is formed on an outer periphery of the sliding sleeve (20), and at least a through hole (208) is formed on the reduced diameter section (207). Moreover, the through hole (208) communicated with the driving hole (203) is adapted to accommodate a second positioning ball (21). The quick release member (30) has a connecting ring (31), an elastic member (32), a stop clip (33), and a cylindrical body (34), and the connecting ring (31) and the elastic member (32) are sequentially sleeved onto the reduced diameter section (207) of the sliding sleeve (20), and the stop clip (33) is engaged with the reduced diameter section (207) to prevent the elastic member (32) and the connecting ring (31) from detaching from the reduced diameter section (207), and the elastic member (32) is compressed between the connecting ring (31) and the stop clip (33). The cylindrical body (34) comprises a first opening (341) and a second opening (342), and a diameter of the second opening (342) is smaller than a diameter of the first opening (341), so that the second opening (342) is connected to the cylindrical body (34) through an inclined section (343). When the cylindrical body (34) is fitted over the stop clip (33), the elastic member (32), and the connecting ring (31) on the reduced diameter section (207), the first opening (341) and the connecting ring (31) are mutually and securely engaged. The cylindrical body (34) is adapted to drive the connecting ring (31) to have displacement, and when released, the connecting ring (31) is pushed back by the elastic member (32), so that the inclined section (343) is configured to control the protrusion or retraction of the second positioning ball (21).

In one embodiment, the rod body (101) has a connecting portion (106) with a hexagonal cross section at an end opposite to the connecting section (103), and an engaging recess (107) is formed on the connecting portion (106), and the connecting rod (10) is adapted to connect to an electric tool or a pneumatic tool through the connecting portion (106) and the engaging recess (107).

In another embodiment, the positioning pin (13) is shaped into a cap, so that one end of the first spring (12) is adapted to be fitted into and abutted against an interior of the positioning pin (13).

In still another embodiment, a serrated pattern (311) is formed on the connecting ring (31), so that the connecting ring (31) is securely engaged with the cylindrical body (34) through the serrated pattern (311).

In a further embodiment, the stop clip (33) is a C-shaped clip.

In still a further embodiment, the first opening (341) of the cylindrical body (34) is secured directly onto the connecting ring (31).

In a preferred embodiment, a first ring (35) is abutted between the connecting ring (31) and the first spring (32).

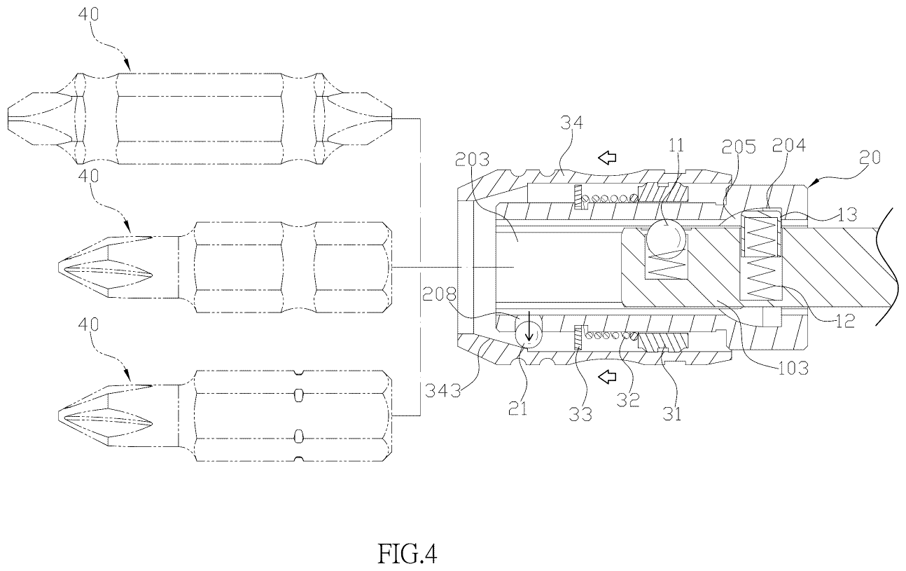

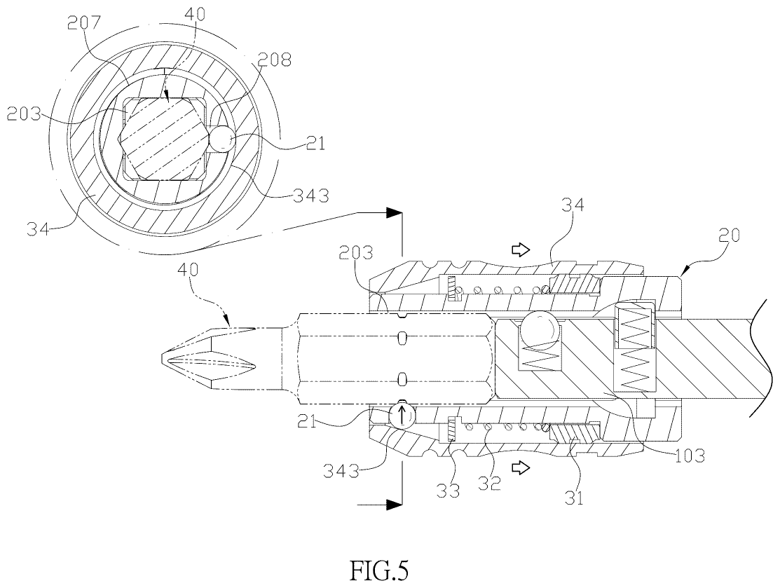

In actual application, by pushing the cylindrical body (34) forward, the second positioning ball (21) is temporarily not abutted against by the inclined section (343) and moved out of the driving hole (203). During the forward movement of the cylindrical body (34), the sliding sleeve (20) is simultaneously driven forward, and the connecting section (103) is fully inserted into the driving hole (203), so that a space is created within the driving hole (203) for various screwdriver tool bits (40) to be inserted (as shown in FIG. 4). When the screwdriver tool bit (40) is inserted into the driving hole (203) and the user's hand holding the cylindrical body (34) is released, the cylindrical body (34) is pushed back to its original position by the elastic member (32), and the inclined section (343) is configured to once again press against the second positioning ball (21) inward, so as to secure the screwdriver tool bit (40) in the driving hole (203) through the second positioning ball (21) (as shown in FIG. 5). As a result, the sliding sleeve (20) can no longer be pushed backward, and the connecting section (103) is consequently unable to extend out of the driving hole (203), which eliminates the risk of the screwdriver tool bit (40) being unintentionally ejected from the driving hole (203). Additionally, as the sliding sleeve (20) moves forward, the positioning pin (13) is actively engaged into the locking groove (204) by the elastic force of the first spring (12), thereby limiting the maximum travel range of the sliding sleeve (20).

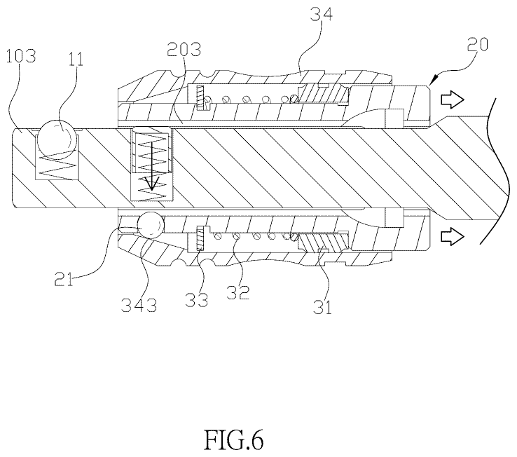

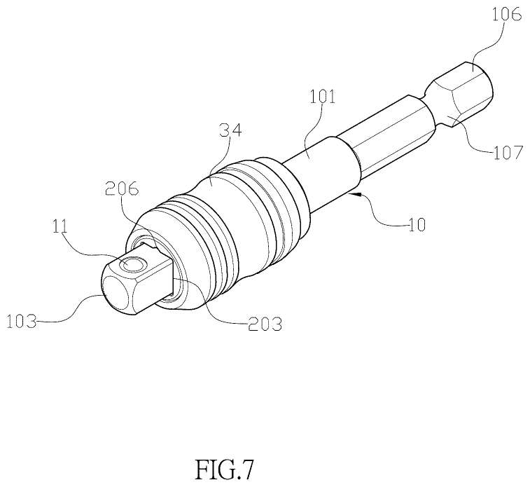

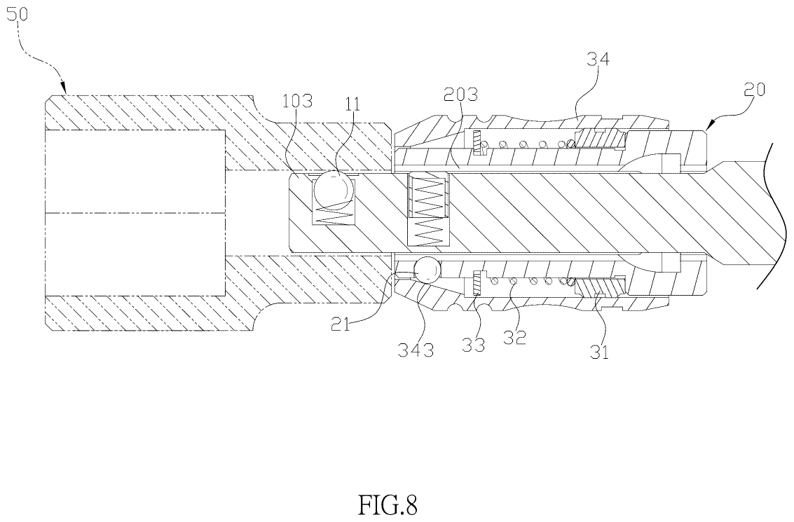

Conversely, when the screwdriver tool bit (40) is removed by pushing the cylindrical body (34) forward, the sliding sleeve (20) can then be pushed backward, allowing the connecting section (103) to extend forward out of the driving hole (203), and the exposed connecting section (103) can then be used to connect to a socket (50) (as shown in FIGS. 6 to 8). During the backward movement of the sliding sleeve (20), the first end (201) of the sliding sleeve (20) and the stop edge (104) are abutted against each other so as to ensure the sliding sleeve (20) to be securely stopped and prevent the sliding sleeve (20) from detaching.

Comparing with conventional tool with quick-release bits, the present invention is advantageous because: by utilizing the quick release member (30) to securely lock the screwdriver tool bit (40) when the screwdriver tool bit (40) is inserted into the driving hole (203), the sliding sleeve (20) is prevented from being pushed backward, and the connecting section (103) is consequently unable to extend out of the driving hole (203). As a result, the screwdriver tool bit (40) has no risk to be directly ejected from the driving hole (203) by the connecting rod (10), so as to eliminate the need to pick the screwdriver tool bit (40) again or the potential the screwdriver tool bit (40) to be lost, thereby making the tool with quick-release bits of the present invention significantly more convenient to use.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A tool with quick-release bits comprising a connecting rod, a sliding sleeve, and a quick release member;
wherein the connecting rod has a cylindrical rod body, and a plurality of equally-angled cut surfaces are formed on an outer periphery of one end of the rod body to form a quadrilateral-shaped connecting section, and with the cut surfaces, the rod body has a reduced outer diameter on the connecting section, so that a stop edge is formed at the junction between the rod body and the connecting section; a first positioning ball is embedded in the connecting section, and the connecting section is recessed with a receiving hole, and a first spring and a positioning pin are sequentially accommodated into the receiving hole;
wherein the sliding sleeve comprises a first end and a second end, and a driving hole with a quadrilateral-shaped cross section extends through between the first end and the second end; a locking groove formed in the driving hole is located adjacent to the first end, and the locking groove is connected to the driving hole toward the direction of the second end through a guiding surface, and at least two opposite edges of the driving hole respectively have a notch at a central portion thereof; the sliding sleeve is sleeved onto the connecting section through the driving hole, and the first spring is adapted to push the positioning pin into the locking groove to engage each other, or through mutual abutment between the first end and the stop edge, the sliding sleeve is configured to slide within a limited range on the connecting rod; a reduced diameter section located away from the first end is formed on an outer periphery of the sliding sleeve, and at least a through hole is formed on the reduced diameter section; the through hole communicated with the driving hole is adapted to accommodate a second positioning ball; and
wherein the quick release member has a connecting ring, an elastic member, a stop clip, and a cylindrical body, and the connecting ring and the elastic member are sequentially sleeved onto the reduced diameter section of the sliding sleeve, and the stop clip is engaged with the reduced diameter section to prevent the elastic member and the connecting ring from detaching from the reduced diameter section, and the elastic member is compressed between the connecting ring and the stop clip; the cylindrical body comprises a first opening and a second opening, and a diameter of the second opening is smaller than a diameter of the first opening, so that the second opening is connected to the cylindrical body through an inclined section; when the cylindrical body is fitted over the stop clip, the elastic member, and the connecting ring on the reduced diameter section, the first opening and the connecting ring are mutually and securely engaged; and the cylindrical body is adapted to drive the connecting ring to have displacement, and when released, the connecting ring is pushed back by the elastic member, so that the inclined section is configured to control the protrusion or retraction of the second positioning ball.

2. The tool with quick-release bits of claim 1, wherein the rod body has a connecting portion with a hexagonal cross section at an end opposite to the connecting section, and an engaging recess is formed on the connecting portion.

3. The tool with quick-release bits of claim 1, wherein the positioning pin is shaped into a cap, so that one end of the first spring is adapted to be fitted into and abutted against an interior of the positioning pin.

4. The tool with quick-release bits of claim 1, wherein a serrated pattern is formed on the connecting ring.

5. The tool with quick-release bits of claim 1, wherein the stop clip is a C-shaped clip.

6. The tool with quick-release bits of claim 1, wherein a first ring is abutted between the connecting ring and the first spring.
